(19) United States
(12) Patent Application Publication
(10) Pub. No.: US 2026/0307769 A1
(43) Pub. Date: Oct. 8, 2026

(54) REMOTELY OPERATED TOWED VEHICLE FOR SUB-SEABED SONAR IMAGING

(71) Applicant: FNV IP B.V., Leidschendam (NL)

(72) Inventors: Peter Willem NIEUWVELD, The Hague (NL); Rik WEMMENHOVE, The Hague (NL); Jacob Joseph IRWIN, Lafayette, LA (US)

(73) Assignee: FNV IP B.V., Leidschendam (NL)

(21) Appl. No.: 19/171,007

(22) Filed: Apr. 4, 2025

(51) Int. Cl. B63G 8/42; B63G 8/00; B63G 8/20; B63G 8/39; G01S 15/89; G01V 1/18; G01V 1/38

(52) U.S. Cl. CPC B63G 8/42; B63G 8/001; B63G 8/20; B63G 8/39; G01S 15/8993; G01V 1/186; G01V 1/3835; G01V 1/3852; B63G 2008/007; G01V 2210/121; G01V 2210/1297; G01V 2210/1427

(57) ABSTRACT

An ROTV for sub-seabed sonar imaging is disclosed. The ROTV has a main hull configured to be towed in water by a vessel, the main hull extending in a horizontal direction perpendicular to a direction of tow. It is equipped with a sound velocity sensor, a positioning system, an altimeter, with the positioning system and the altimeter having different operating frequencies. The ROTV comprises a payload in the form of a plate comprising at least one receiver panel and at least two sound projectors, the sound projectors arranged such that they are horizontally spaced from each other in said horizontal direction. The plate is rigidly connected to the main hull of the ROTV. A controller configured to control operation of the ROTV is also provided on board the ROTV. The ROTV is versatile, easily controllable and allows the collection of reliable and high-resolution data for sonar imaging of sub-seabed features. Unlocking insights from Geo-Data, the present invention further relates to improvements in sustainability and environmental developments: together we create a safe and liveable world.

### TECHNICAL FIELD

This disclosure relates to a remotely operated towed vehicle for sub-seabed sonar imaging. The disclosure further relates to a system comprising the remotely operated towed vehicle and a heave compensated winch. Unlocking insights from Geo-Data, the present invention further relates to improvements in sustainability and environmental developments: together we create a safe and liveable world.

### BACKGROUND

There is a general and ongoing need to improve the effectiveness of sub-seabed sonar imaging. Sub-seabed sonar imagining involves scanning marine environments to detect buried objects, such as unexploded items of ordnance (UXO), anchors and cables-among many other. Detection of objects like these is especially important for subsea construction projects, like the construction of wind farms. In particular, there is a need for a remotely operated towed vehicle which can be used to scan the marine environment to detect such submerged objects which has improved deployment capabilities and higher resolution than existing approaches.

A known approach to sub-seabed sonar imaging is deploying a sonar sensor on a deployment structure. Typically, the deployment structure is a trailing deployment structure which is towed through the water by, for example, a boat. As the deployment structure is towed, the sonar sensor emits sound waves, which travel through water and bounce back after hitting objects buried under the seabed. These reflected sound waves are then analyzed to identify buried objects. Using appropriate apparatus and operation, three-dimensional (“3D”) images of the sub-seabed may also be generated to gain further insights on any identified buried objects.

There is a specific desire to improve the deployment capabilities and resolution of known approaches to sub-seabed sonar imaging. Deployment structures of the prior art may be relatively large and heavy. As such, they may be difficult to manoeuvre and deployment may be cumbersome. The weight and size of some existing deployment structure may mean that they can only be deployed from a vessel capable of handling such large hardware. This leads to reduced operability.

Further, trailing arrangements of known deployment structures may present safety risks to personnel on board the deployment vessel. This is especially the case during launch and recovery of the deployment structures to and from the sea when, typically, the heavy structures are manipulated from the vessel to the sea using a single lifting point. It can be difficult to control the motion of the deployment structure while being lifted, especially during adverse weather conditions, which presents a safety risk to on-board personnel.

Further still, trailing arrangements of deployment structures known from the prior art may result in limited control over the deployment structure. As such, the manoeuvrability of existing deployment structures when in the water may be limited. Limited manoeuvrability may prevent the deployment structure from adjusting the positioning of the sonar sensor in response to varying seabed terrain and changing currents and conditions. Manoeuvrability is crucial to gather detailed and accurate data from sub-seabed sonar imaging.

In addition, to allow the trailing arrangement of a prior art deployment structure to be towed through water, it must be connected to, for example, a remotely operated boat. As such, known solutions may be mechanically complex due to articulation points between the trailing deployment structure and the remotely operate boat. As a result, the stability of the structure when towed in water may be limited and unknown sources of error may be introduced in the positioning of the device. Therefore, the accuracy of results produced using known techniques may be limited.

Finally, the sonar sensors of known implementations for sub-seabed 3D sonar imaging typically use low-frequency sound waves to allow for deep penetration into the seabed. However, low frequency ranges offer relatively low resolutions. As such, finer details of the sub-seabed object may be difficult to capture. Further, prior art sonar sensors may use a limited number of hydrophones, which compounds any lack of imaging resolution: while a limited number of hydrophones offers reduced cost, complexity, and size, such a limitation also reduces the resolution of the generated data.

There is therefore a need for an improved remotely operated towed vehicle for sub-seabed sonar imaging. This disclosure aims to solve at least one of the abovementioned problems associated with sub-seabed sonar imaging.

### OVERVIEW

A remotely operated towed vehicle (ROTV) for sub-seabed sonar imaging is disclosed. The ROTV comprises a main hull, a sound velocity sensor, a positioning system, an altimeter, a payload, and a controller configured to control the operation of the ROTV. The main hull is configured to be towed in water by a vessel, such as a towing boat, and extends in a horizontal direction, generally perpendicular to a direction of tow. The positioning system and the altimeter have different operating frequencies. The payload is provided generally in the form of a plate and comprises at least one receiver panel and at least two sound projectors. The sound projectors are arranged such that they are horizontally spaced from each other in said horizontal direction. The plate is rigidly connected to the ROTV. The receiver panel may advantageously be positioned between the sound projectors, optionally generally along the same direction, which may be a horizontal direction parallel with the horizontal direction along which the main hull of the ROTV described herein extends.

Advantageously, the integration of at least one receiver panel and at least two sound projectors with the main hull of an ROTV as described herein results in a simplified design of a sub-seabed sonar imaging device over the known art. In particular, the ROTV provides a means of sub-seabed sonar imaging without the need for complex trailing structures. This increases ease of deployment. Furthermore, the safety of personnel handling the ROTV is increased as the apparatus is easier to control during launch and recovery of the ROTV to and from the sea. In addition, due to the mitigated need for a complex trailing structure, the ROTV can be deployed alongside traditional magnetometer deployment frames. As such, sub-seabed sonar imaging can be carried out during a towed unexploded ordnance survey, enabling acoustic and magnetic data collection in every survey line. Thus, the operational efficiency of each survey is increased. Further, the horizontal spacing of the sound projectors results in increased survey swath width. This results in fewer survey lines being required, which results in more efficient surveying. Finally, providing the payload in the form of a plate, rigidly connected to the main hull of the ROTV, ensures a fixed spatial relationship between the receiver panel and sound projectors. This increases the accuracy of the data provided by the ROTV and reduces unknown sources of error.

In some examples, the plate comprises at least four receiver panels, each receiver panel comprising a plurality of hydrophones. In an example, the plate comprises at least four receiver panels, each receiver panel comprising at least 2 hydrophones, advantageously at least 4 hydrophones, more advantageously at least 8 hydrophones, still more advantageously at least 16 hydrophones.

Advantageously, the plurality of receiver panels results in increased spatial coverage. As such, fewer survey lines may be required. The high number of total hydrophones, and/or of hydrophones per receiver panel, may results in an increased resolution of the data generated by the ROTV. Further, the directional accuracy of the data may be improved.

In some examples, the plate may be directly attached to a lower surface of the main hull. “Directly”, as used herein, means without intermediate structures. However, it will be appreciated that in alternative embodiments (less preferred), the plate may be indirectly attached to the main hull of the ROTV, which means that the connection is via one or more intermediate structures, which may be of different types and sorts.

Advantageously, the direct attachment of the plate to the lower surface of the main hull would reduce unwanted hydrodynamic effects of the plate and/or of the main hull. In particular, excessive motion reaction of the ROTV to small adjustments in target altitude may be prevented in this way. As such, the stability of the ROTV would be increased, and thus the quality of the data generated by the ROTV would be improved. In addition, direct attachment of the plate to the lower surface of the main hull of the ROTV would provide the ability to directly thread cables from, for example, the sound projectors and receiver panel into the main hull of the ROTV, which further enables a generally compact design for the ROTV described herein.

In some examples, the ROTV may comprise at least two vertically disposed actuators arranged on horizontally opposite sides of the ROTV. The at least two vertically disposed actuators would be configured to control lateral movement of the ROTV.

Advantageously, the ROTV may be able to navigate both vertically and horizontally though the water. This would result in greater flexibility in executing survey run lines.

In some examples, the positioning system, the sound velocity sensor, and/or the altimeter may be directly attached to the plate.

Advantageously, deflection between the receiver panel and sound projectors, and the positioning system, the sound velocity sensor, and/or the altimeter would be prevented, or in any event, limited. As such, the accuracy and reliability of the generated data may be increased.

In some examples, the controller may be configured to operate the at least two sound projectors independently one of the other.

Advantageously, the resolution of data generated by the ROTV would be increased as each sound projector can emit sonar signals from different angles. Further, the accuracy of the generated data would be increased due to improved triangulation.

In some examples, the at least two projectors may be CHIRP projectors.

Advantageously, CHIRP signals would sweep across a range of frequencies, allowing for detection of objects at different depths or distances. This would make it easier to identify targets that are located at varying depths. Further, CHIRP projectors would be less affected by background noise and thus have a high signal-to-noise ratio.

In some examples, each projector may be capable of emitting sound in water in the frequency range of 5 kHz to 25 kHz.

Advantageously, the ability to transmit over a broad frequency spectrum would improve the range (of distances) at which buried objects or sub-seabed features can be detected.

In some examples, the positioning system may comprise an inertial measurement unit and a doppler velocity log.

Advantageously, the provision of an inertial measurement unit with a doppler velocity log would provide additional reliability to the positioning system.

In some examples, the positioning system may have an operating frequency within the range of 400 kHz to 600 kHz.

Advantageously, such a frequency range would not interfere with the frequency range of any other instruments on board the ROTV.

In some examples, the altimeter may have an operating frequency within the range of 100 kHz to 300 kHz.

Advantageously, high altitude resolution is provided because the altimeter allows for fine measurements of distance. As such, high accuracy of altitude measurement is improved.

In some examples, the controller may comprise a fibre optic multiplexer. The fibre optic multiplexer may be attached to a top surface of the main hull.

Advantageously, the fibre optic multiplexer would facilitate the transmission of several data signals simultaneously over a single transmission line. As such, the complexity of the data transmission system would be reduced. Further, fibre optic cabling would offer high bandwidth and transmission speed for large amounts of data.

Also disclosed is a system comprising at least one ROTV as disclosed herein. The system may comprise an ROTV and a heave compensated winch.

Advantageously, the heave compensated winch may actively adjust the length of a cable connecting the ROTV to a towing vessel, such as boat, in response to wave induced heave motion of the vessel/boat. As such, any tugging exerted on the ROTV can be significantly reduced, resulting in fewer required altitude adjustments and thus a more stable ROTV in operation.

In some examples, the heave compensated winch may comprise a winch cable configured to provide data, power, and/or control connections between the vessel and the ROTV.

Advantageously, such a winch cable would facilitate transmission of data between the ROTV and the vessel/boat, alongside providing a force to pull the ROTV through the water.

In some examples, the winch cable may be a fibre-optic cable.

Advantageously, the bandwidth of the winch cable would be improved. As such, the speed and reliability of data transmission would be increased.

The term “apparatus” or “system” as used herein may refer to either a single apparatus or system or plural apparatus or systems and should not be understood as being particularly limited to either a single discrete apparatus or system, or a plurality of discrete apparatus or systems, unless a particular apparatus or system is further described as such.

The above mentioned and other features and advantages of the disclosure will be best understood from the following description referring to the attached drawings. In the drawings, like reference numerals denote identical parts or parts performing an identical or comparable function or operation.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 shows a perspective view of an implementation of the disclosure showing a remotely operated towed vehicle;

FIG. 2 shows a bottom view of the implementation of the disclosure of FIG. 1;

FIG. 3 shows a side view of the implementation of the disclosure of FIG. 1 and FIG. 2;

FIG. 4 shows a front view of the implementation of the disclosure of FIGS. 1 to 3; and,

FIG. 5 shows schematically a side view of an implementation of the disclosure showing a system including a remotely operated towed vehicle as disclosed herein, and a heave compensated winch.

### DETAILED DESCRIPTION

Examples contemplated by the present disclosure will now be described in more detail with reference to the accompanying drawings. The disclosed subject matter should not be construed as limited to only the embodiments set forth herein. Rather, the illustrated embodiments are provided by way of example to convey the scope of the subject matter to those skilled in the art.

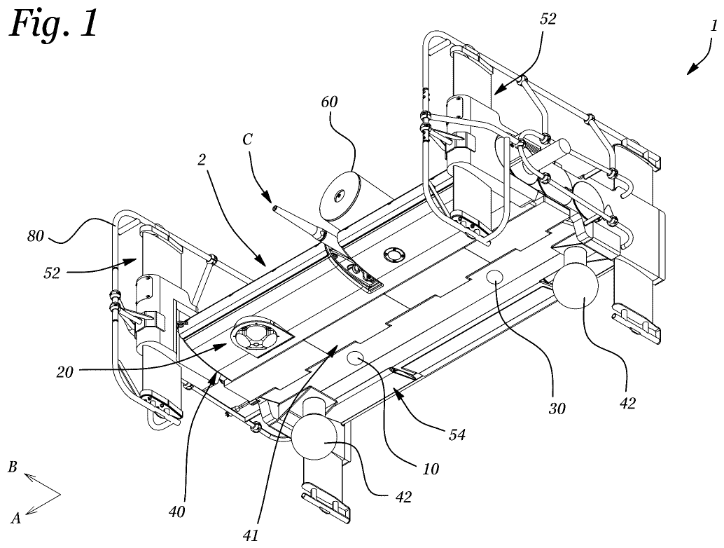

FIG. 1 shows a perspective view of an implementation of the disclosure. In the shown implementation, a remotely operated towed vehicle (hereafter, ROTV) 1 is shown. The ROTV 1 is configured to create three-dimensional (3D) sonar images of the sub-seabed marine environment. As such, the ROTV 1 may be configured to locate objects buried in the seabed.

The ROTV 1 includes a main hull 2. The main hull 2 is configured to be towed in water by a vessel. The main hull 2 has a horizontal axis A and an axis of travel B. The axis of travel B and the horizontal axis A are substantially perpendicular to each other. The horizonal axis A is substantially parallel to the span of the main hull 2. It follows that the axis of travel is substantially perpendicular to the span of the main hull 2. In use, the main hull 2 is towed through water by a vessel in a direction generally aligned with the axis of travel B.

The ROTV 1 may be configured to be towed in water at speeds within the range of 1 knot to 10 knots. The ROTV 1 may be configured to be towed in water at speeds within the range of 1 knot to 8 knots. The ROTV 1 may be configured to be towed in water at speeds within the range of 2 knots to 5 knots.

The ROTV 1 may be configured to operate in water depths up to 1000 m.

The main hull 2 may be configured to control the vertical movement of the ROTV 1 as it is towed through the water by a vessel. That is, the main hull 2 of the ROTV 1 may be generally in the shape of a hydrofoil. The hydrofoil may have a reconfigurable hydrofoil surface, which may be controlled by one or more actuators, as described further below. The main hull 2 of the ROTV 1 may be in any other shape suitable to be towed through water by a vessel.

In the shown implementation, the ROTV 1 has a span of 2 m. That is, the ROTV 1 has a width in the horizontal direction A of 2 m. In some examples, the ROTV may have a span of less than 2 m. In some examples, the ROTV may have a span of less than 1.5 m. Advantageously, a span of 2 m or less allows the ROTV to be deployed from small vessels, such as boats with limited space and handling capabilities. In some examples, the span of the main hull 2 may correspond with the span of the ROTV 1. That is, the width of the main hull 2 in the horizontal direction A may correspond with the width of the ROTV 1 in the horizontal direction A. In some examples, the span of the main hull 2 may be less than the span of the ROTV 1. That is, the width of the main hull 2 in the horizontal direction A may be less than the width of the ROTV 1 in the horizontal direction A.

The ROTV 1 may include at least one horizontally disposed actuator 54. In the shown implementation, the ROTV 1 includes two horizontally disposed actuators 54. The ROTV 1 may include three horizontally disposed actuators 54. The ROTV 1 may include any appropriate number of horizontally disposed actuators 54.

The horizontally disposed actuators 54 may be connected to the trailing edge of the main hull 2 of the ROTV 1. The horizontally disposed actuators 54 may be configured to move in order to adjust the lift produced by the ROTV 1. As such, the horizontally disposed actuators 54 may be configured to control the vertical movement of the ROTV 1 in water, when towed.

The ROTV 1 includes a payload in the form of a plate 40. The plate 40 is positioned below the lower surface of the main hull 2 of the ROTV 1. The plate 40 is rigidly connected to the main hull 2 of the ROTV 1. As such, a fixed relationship between the plate 40 and the main hull 2 is defined. In some examples, the plate 40 may be rigidly connected to main hull 2 via an intermediate component (in these instances, the connection may be qualified as “indirect”). For example, the plate 40 may be indirectly rigidly connected to the main hull 2 via an outer framework structure 80. The outer framework structure 80 may define a notional envelope around the ROTV 1. The plate 40 may be positioned within the notional envelope defined by the framework structure 80. The plate 40 may be positioned such that the maximum distance between the plate 40 and the main hull 2 is less than 0.2 m. Preferably, the maximum distance between the plate 40 and the main hull 2 may be less than 0.1 m. Preferably, the maximum distance between the plate 40 and the main hull 2 may be less than 0.05 m. In a preferable implementation shown in FIG. 1, the plate 40 is directly attached to the lower surface of the main hull 2 of the ROTV 1. That is, there is no distance between the plate 40 and the main hull 2, since these two parts are directly attached to each other.

In the shown implementation, the span of the plate 40 corresponds to the span of the main hull 2. In some examples, the span of the plate 40 may be less than the span of the main hull 2. The plate 40 must be large enough to carry at least two sound projectors 42 and at least one receiver panel 41, as discussed in more detail below.

The ROTV 1 includes at least two sound projectors 42. In the shown implementation, the ROTV 1 has two sound projectors 42. In other examples, the ROTV 1 may have more than two sound projectors 42. For example, the ROTV 1 may have four sound projectors 42.

The sound projectors 42 are directly attached to the plate 40. As such, the sound projectors 42 are rigidly connected also to the main hull 2 of the ROTV 1.

The sound projectors 42 are arranged such that they are horizontally spaced from each other along the horizontal axis A. It follows that the sound projectors 42 are horizontally spaced from each other along the span of plate 40. The sound projectors 42 may be arranged such that there is a maximal horizontal spacing between each of the sound projectors. Said maximal horizontal spacing may be limited by the span of the plate 40.

In the shown implementation, the sound projectors 42 are spherical sound projectors, thus directional projectors. The sound projectors 42 may be hemispherical sound projectors. The sound projectors 42 may be cylindrical sound projectors.

The sound projectors 42 may be configured to emit sound waves covering a wide angle. That is, the sound projectors 42 may be configured to maximise the swath coverage of the ROTV 1. For example, the sound projectors 42 may be configured to emit sound waves covering an angle of 360 degrees. For example, the sound projectors 42 may be configured to emit sound waves covering an angle of 270 degrees. For example, the sound projectors 42 may be configured to emit sound waves covering an angle of 180 degrees. For example, the sound projectors 42 may be configured to emit sound waves covering an angle of 150 degrees.

The sound projectors 42 may be CHIRP sound projectors. That is, the sound projectors 42 may be capable of emitting a sound wave that sweeps through a range of frequencies over time. For example, the sound projectors 42 may be capable of emitting a sound wave in water that sweeps through the frequency range of 2 kHz to 10 kHz. For example, the sound projectors 42 may be capable of emitting a soundwave in water that sweeps through the frequency range of 2 kHz to 15 kHz. For example, the sound projectors 42 may be capable of emitting a soundwave in water that sweeps through the frequency range of 5 kHz to 25 kHz. For example, the sound projectors 42 may be capable of emitting a soundwave in water that sweeps through the frequency range of 5 kHz to 35 kHz.

The sound projectors 42 may be configured such that they can be operated independently from one another.

The ROTV 1 includes at least one receiver panel 41. The receiver panel 41 is directly attached to the plate 40. It follows that the receiver panel 41 is rigidly connected to the main hull 2 of the ROTV 1. Due to the receiver panel 41 being directly attached to the plate 40, there is a fixed displacement between the receiver panel 41 and the sound projectors 42.

In the shown implementation, the ROTV 1 has one receiver panel 41. The ROTV 1 may have a plurality of receiver panels 41. For example, the ROTV 1 may have two receiver panels 41. For example, the ROTV 1 may have four receiver panels 41. The plurality of receiver panels 41 may be arranged along the span of the plate 40. The plurality of receiver panels 41 may be arranged end-to-end such that they extend from one end of the plate 40 to the opposite end of the plate 40 in the horizontal direction A.

Each of the receiver panels 41 has a plurality of hydrophones. For example, each receiver panel may have at least four hydrophones. For example, each receiver panel 41 may have at least eight hydrophones. For example, each receiver panel 16 may have at least sixteen hydrophones. For example, each receiver panel may have any other appropriate number of hydrophones to achieve the desired resolution of data generated by the ROTV 1.

The ROTV includes a positioning system 20. The positioning system 20 is positioned such that the displacement (i.e., the relative distance) between the positioning system 20, the sound projectors 42 and receiver panel(s) 41 is structurally and spatially fixed. The positioning system 20 may be positioned such that the displacement between the positioning system 20, the sound projectors 42 and receiver panels 41 is minimised. Preferably, as shown in FIG. 1, the positioning system 20 may be directly attached to the plate 40.

The positioning system 20 may include multiple positioning instruments. For example, the positioning system 20 may include an inertial navigation system(INS) unit. For example, the positioning system 20 may include a doppler velocity log (DVL). For example, the positioning system 20 may include an altimeter. For example, the positioning system 20 may include an attitude and heading reference system (AHRS). For example, the positioning system 20 may include a pressure sensor.

The positioning system 20 may be configured to accurately measure the movement of the ROTV 1 relative to its last position. The positioning system 20 may be configured to measure the altitude of the ROTV 1 with high resolution and frequency. The positioning system 20 may be configured to measure the roll of the ROTV 1. For example, the positioning system 20 may measure the roll of the ROTV 1 to an accuracy within the range of 0.01 to 0.02 degrees. The positioning system 20 may be configured to measure the pitch of the ROTV 1. For example, the positioning system 20 may measure the pitch of the ROTV 1 to an accuracy within the range of 0.01 to 0.02 degrees. The positioning system 20 may be configured to measure the heading angle of the ROTV 1. For example, the positioning system 20 may measure the heading angle of the ROTV 1 to an accuracy within the range of 0.1 to 0.2 degrees.

The positioning system 20 may be part of an absolute positioning system distributed between the ROTV 1 and a vessel by which the ROTV 1 is towed through water. The vessel may include a topside positioning system. The vessel may be accurately positioned using corrected and aided global navigation satellite system (GNSS) signals and GNSS receivers. The motion of the vessel may be measured using an INS unit on the vessel. The ROTV 1 may be positioned relative to the vessel via ultra-short baseline (USBL) acoustic signaling. For example, a beacon (not shown) may be mounted on the main hull 2 of the ROTV 1 which is configured to respond to “pings” from a USBL sonar head which may be be mounted on the vessel. The acoustic signal returned from the beacon on the ROTV 1 may be positioned by the USBL system, for example, by range and direction calculations. As such, the subsea position of the ROTV 1 may be provided relative to the accurately positioned vessel. As such, the position of the ROTV 1 may be locally accurate on a point-to-point basis, but is also globally related and bounded.

The plate 40 is configured such that it is strong enough to hold the receiver panels 41 and sound projectors 42 without deflecting. In some examples, the plate 40 may be configured such that it is strong enough to hold the receiver panels 41, the sound projectors 42, and the positioning system 20 without deflecting. In some examples, the plate 40 may be configured such that it is strong enough to hold a number of components without deflecting. The plate 40 is configured such that it does not deflect when the ROTV 1 is towed through water. The plate 40 may be made of any material strong enough to withstand deflection. For example, the plate 40 may be made of metal such as steel. For example, the plate 40 may be made of a composite material.

The ROTV 1 includes a sound velocity sensor 10 (hereafter, SVS). The SVS 10 may be configured to measure sound velocity using time-of-flight of a pulse of sound in water. The SVS 10 is rigidly connected to the main hull 2 of the ROTV 1. The SVS 10 may be positioned below the lower surface of the main hull 2. In the shown implementation, the SVS 10 is directly attached to the plate 40 which is rigidly connected to the lower surface of the main hull 2.

The ROTV includes an altimeter 30. The altimeter 30 is rigidly connected to the main hull 2 of the ROTV 1. The altimeter 30 is positioned below the lower surface of the main hull 2. In the shown implementation, the altimeter 30 is directly attached to the plate 40 which is rigidly connected to the lower surface of the main hull 2.

The altimeter 30 may have an operating frequency which differs from the operating frequency of the positioning system 20. The altimeter 30 may be configured to have an operating frequency in the range of 50 kHz to 350 kHz. The altimeter 30 may be configured to have an operating frequency in the range of 100 kHz to 300 kHz. The altimeter 30 may be configured to have an operating frequency in the range of 150 kHz to 250 kHz.

The ROTV 1 may, in addition, include at least two vertically disposed actuators 52. In the shown implementation, the ROTV 1 includes four vertically disposed actuators 52. In another implementation, the ROTV 1 may include six vertically disposed actuators 52. In another implementation, the ROTV 1 may include any appropriate number of vertically disposed actuators 52.

The vertically disposed actuators 52 are configured to control the horizontal movement of the ROTV 1. The vertically disposed actuators 52 may be configured to move in order to control the horizontal movement of the ROTV 1.

The vertically disposed actuators 52 may also be provided generally in the shape of a hydrofoil. The vertically disposed actuators 52 may be any other appropriate shape to control the horizontal movement of the ROTV 1.

The vertically disposed actuators 52 are arranged such that they are horizontally spaced from each other along the horizontal axis A of the ROTV 1. The vertically disposed actuators 52 may be arranged on horizontally opposite ends of the ROTV 1.

The ROTV 1 may include at least one drogue (not shown). The drogue may be positioned behind the main hull 2 of the ROTV 1. The drogue may be configured to increase the drag of the ROTV 1 as it is towed through the water. Advantageously, the increased drag may dampen the rapid vertical adjustments of the ROTV 1 due to cable tugging. As such, a more stable ROTV 1 may be provided.

The ROTV 1 includes a controller. The controller is configured to control the operation of the ROTV 1.

The controller may be configured to operate the ROTV 1 such that the ROTV 1 has a survey swath width within the range of 10 m to 100 m. The controller may be configured to operate the ROTV 1 such that the ROTV 1 has a survey swath width within the range of 15 m to 80 m. The controller may be configured to operate the ROTV 1 such that the ROTV 1 has a survey swath width within the range of 20 m to 60 m.

The controller may be configured to operate the ROTV 1 such that the ROTV 1 may provide acoustic measurements with a space resolution within the range of 0.02 m to 0.15 m. The controller may be configured to operate the ROTV 1 such that the ROTV 1 has a space resolution within the range of 0.02 m to 0.1 m. The controller may be configured to operate the ROTV 1 such that the ROTV 1 has a space resolution within the range of 0.02 m to 0.05 m.

The controller may include a fibre optic multiplexer 60. The fibre optic multiplexer 60 may be connected to the top surface of the main hull 2. The fibre optic multiplexer 60 may be configured to select one of several input signals and route it to a single output. Data generated by the positioning system 20, the SVS system 10, the altimeter 30, and the sound projectors 42 and receiver panel 41 may each be input signals to the fibre optic multiplexer 60.

The ROTV 1 may include a fibre optic extension multiplexer. The fibre optic extension multiplexer may be configured to transmit data over a long distance, for example between a ROTV 1 and a vessel. The fibre optic extension multiplexer facilitates the transmission of multiple signals over a single cable, thereby improving efficiency. Fibre optics offer high bandwidth and transmission speed for large amounts of data.

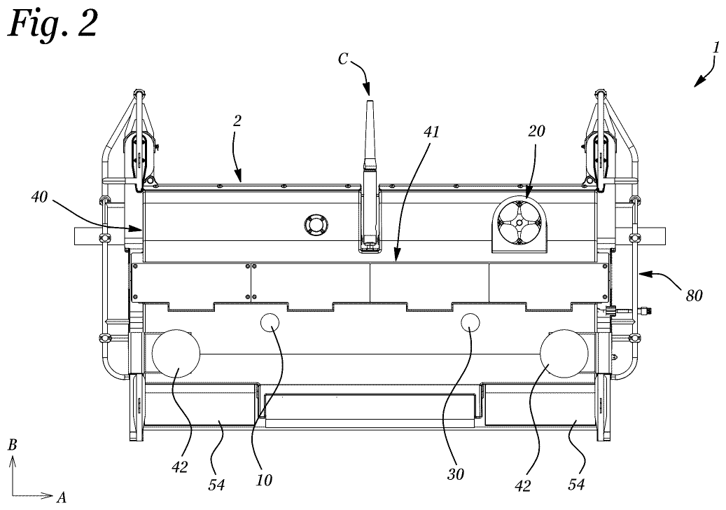

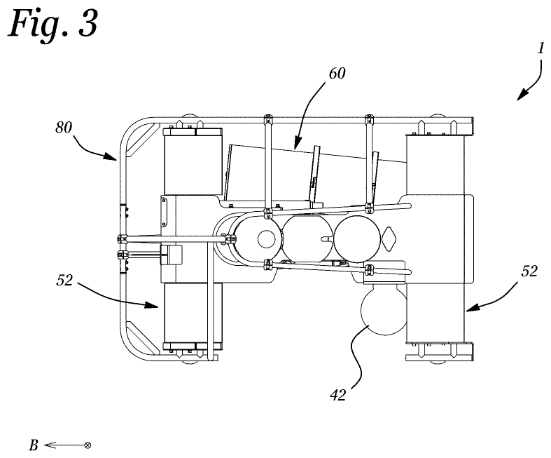

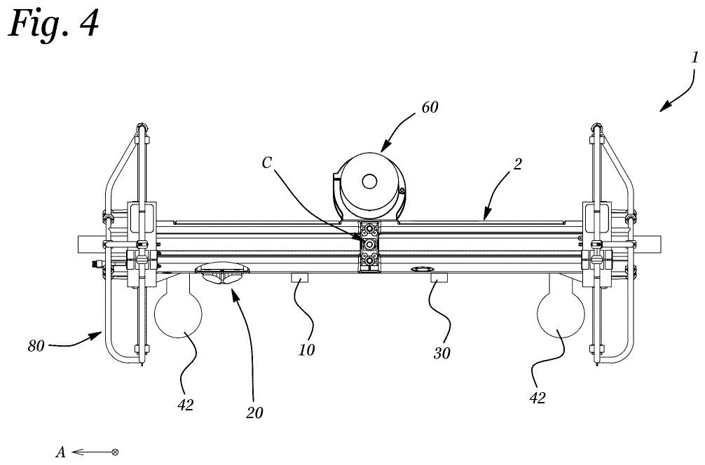

FIGS. 2 to 4 show alternative views of the ROTV 1 as described with reference to FIG. 1. Specifically, FIG. 2 shows a bottom view of the ROTV 1 as described in with reference to FIG. 1. FIG. 3 shows a side view of the ROTV 1 as described with reference to in FIG. 1. FIG. 4 shows a front view of the ROTV 1 as described with reference to in FIG. 1.

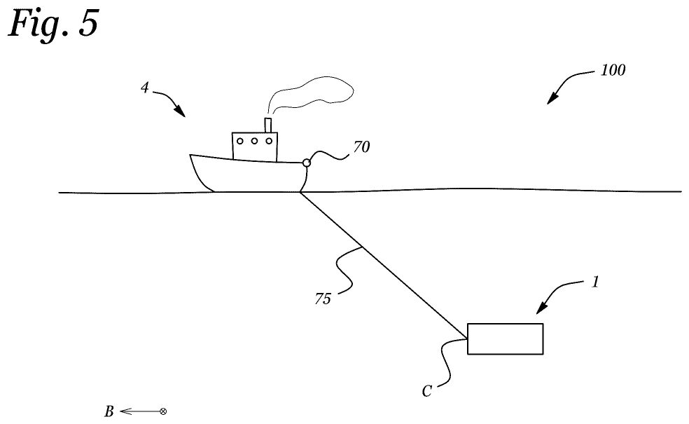

FIG. 5 shows a side view of an implementation of the disclosure in operation. In operation, a ROTV 1 is towed through water by a vessel 4 in a direction generally aligned with the axis of travel B.

In the shown implementation, a system 100 is shown. The system 100 includes a ROTV 1 and a heave compensated winch 70. The ROTV 1 may be the same ROTV 1 as shown in FIGS. 1 to 4.

The heave compensated winch 70 may include a winch cable 75. In some examples, the winch cable 75 may be a payload cable. That is, the winch cable 75 may be configured to connect the ROTV 1 to a vessel 4 such that the ROTV 1 may be towed through water by the vessel 4. For example, the winch cable 75 may be made of steel. For example, the winch cable may be made of any appropriate material for towing the ROTV 1 through water.

The winch cable 75 may be configured to provide data, power, and/or control connections between the vessel 4 and the ROTV 1. In some examples, the winch cable may be a fibre-optic cable. The winch cable 75 may be configured such that it has a minimum bandwidth of at least 110 Mbps. Preferably, the winch cable 75 may be configured such that it has a bandwidth of at least 1 Gbps.

The winch cable 75 of the heave compensated winch 70 may be connected to the ROTV 1 at connection point C. Connection point C may be located on the leading edge of the main hull 2 of the ROTV 1, as shown in FIGS. 1 to 4. Connection point C may be located on an outer framework structure 80 of the ROTV 1.

The preceding detailed description is merely exemplary in nature and is not intended to limit the disclosure and its uses. Furthermore, there is no intention to be bound by any expressed or implied theory presented in the preceding technical field, background, brief summary or the detailed description.

Examples of the present disclosure may be described herein in terms of functional and/or logical block components and various processing steps. It should be appreciated that such block components may be realised by any number of hardware, software, and/or firmware components configured to perform the specified functions. For example, an example of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that examples of the present disclosure may be practised in conjunction with any number of systems, and that the systems described herein are merely exemplary embodiments of the present disclosure.

For the sake of brevity, conventional techniques compared to signal processing, data transmission, signalling, control and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connection may be present in an example of the present disclosure.

Those skilled in the art will recognise that a wide variety of modifications, alterations, and combinations can be made with respect to the above-described examples without departing from the scope of the disclosed concepts, and that such modifications, alterations, and combinations are to be viewed as being within the ambit of the disclosed concepts.

Further modifications in addition to those described above may be made to the structures and techniques described herein without departing from the spirit and scope of the invention. Accordingly, although specific examples have been described, these are examples only and are not limiting upon the scope of the invention.

1. A remotely operated towed vehicle (ROTV) for sub-seabed sonar imaging, the ROTV comprising:
a main hull configured to be towed in water by a vessel, the main hull extending in a horizontal direction perpendicular to a direction of tow;
a sound velocity sensor;
a positioning system;
an altimeter, wherein the positioning system and the altimeter have different operating frequencies;
a payload provided in a form of a plate and comprising at least one receiver panel and at least two sound projectors, the at least two sound projectors arranged such that they are horizontally spaced from each other in said horizontal direction, wherein the plate is rigidly connected to the main hull of the ROTV; and
a controller configured to control operation of the ROTV.

2. The ROTV of claim 1, wherein the plate comprises at least four receiver panels, each receiver panel comprising a plurality of hydrophones.

3. The ROTV of claim 1, wherein the plate is directly attached to a lower surface of the main hull.

4. The ROTV of claim 1, wherein the ROTV comprises at least two vertically disposed actuators arranged on horizontally opposite sides of the ROTV, the at least two vertically disposed actuators being configured to control lateral movement of the ROTV.

5. The ROTV of claim 1, wherein the positioning system, the sound velocity sensor, and the altimeter are directly attached to the plate.

6. The ROTV of claim 1, wherein the controller is configured to operate the at least two sound projectors independently one of one another.

7. The ROTV of claim 1, wherein the at least two sound projectors are CHIRP projectors.

8. The ROTV of claim 1, wherein each sound projector is capable of emitting sound in water in the a frequency range of 5 kHz to 25 kHz.

9. The ROTV of claim 1, wherein the positioning system comprises an inertial measurement unit and a doppler velocity log.

10. The ROTV of claim 1, wherein the positioning system has an operating frequency within a range of 400 kHz to 600 kHz.

11. The ROTV of claim 1, wherein the altimeter has an operating frequency within the a range of 100 kHz to 300 kHz.

12. The ROTV of claim 1, wherein the controller comprises a fibre optic multiplexer.

13. A system comprising:
a remotely operated towed vehicle (ROTV) including:
a main hull configured to be towed in water by a vessel, the main hull extending in a horizontal direction perpendicular to a direction of tow;
a sound velocity sensor;
a positioning system;
an altimeter, wherein the positioning system and the altimeter have different operating frequencies;
a payload provided in a form of a plate and comprising at least one receiver panel and at least two sound projectors, the at least two sound projectors arranged such that they are horizontally spaced from each other in said horizontal direction, wherein the plate is rigidly connected to the main hull of the ROTV; and
a controller configured to control operation of the ROTV; and
a heave compensated winch.

14. The system of claim 13, wherein the heave compensated winch comprises a winch cable configured to provide data, power, and control connections between the vessel and the ROTV.

15. The system of claim 14, wherein the winch cable is a fibre-optic cable.

16. The system of claim 13, wherein the plate comprises at least four receiver panels, each receiver panel comprising a plurality of hydrophones.

17. The system of claim 13, wherein the plate is directly attached to a lower surface of the main hull.

18. The system of claim 13, wherein the ROTV comprises at least two vertically disposed actuators arranged on horizontally opposite sides of the ROTV, the at least two vertically disposed actuators being configured to control lateral movement of the ROTV.

19. The system of claim 13, wherein the positioning system, the sound velocity sensor, and the altimeter are directly attached to the plate.

20. The system of claim 13, wherein the controller is configured to operate the at least two sound projectors independently of one another.
